(19) United States
(12) Patent Application Publication
(10) Pub. No.: US 2008/0176202 A1
(43) Pub. Date: Jul. 24, 2008

(54) Augmenting Lectures Based on Prior Exams

(75) Inventors: Lalitha Agnihotri, Tarrytown, NY (US); Alan Hanjalic, Delft (NL); Mauro Barbieri, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/909,650

(22) PCT Filed: Mar. 29, 2006
(86) PCT No.: PCT/IB06/50957

§ 371 Date: Sep. 25, 2007

Related U.S. Application Data
(60) Provisional application No. 60/666,924, filed on Mar. 31, 2005.
(60) Provisional application No. 60/701,364, filed on Jul. 21, 2005.

(51) Int. Cl. G09B 7/04

(52) U.S. Cl. 434/322

(57) ABSTRACT

A system and method augments a recorded lecture (110) based on the importance of the material and/or based on a student's needs. The importance of each segment of the lecture material (110) is based at least in part on questions from prior exams (120), and the student's needs are based at least in part on the student's performance (130) on prior exams. The method (410-440) of presenting the augmented material to the student may also be customized based on the student's learning style.

This invention relates to the field of information processing, and in particular to a system and method that augments lecture material to facilitate an efficient and effective review of the material.

A variety of systems and methods have been developed and/or proposed for providing aids to students. With the proliferation of image and video capture and processing systems, students often have immediate access to recordings of lectures and slide presentations, as well as the more traditional study aids, such as lecture notes, outlines, prior exams, and so on.

U.S. Pat. No. 6,789,228 “METHOD AND SYSTEM FOR THE STORAGE AND RETRIEVAL OF WEB-BASED EDUCATION MATERIAL”, issued 7 Sep. 2004 to Merril et al., and its continuation-in-part, U.S. Published Application 2002/0036694, filed 20 Sep. 2001 for Jonathan Merril, disclose a system for capturing images and video during a lecture, generating a transcript from the lecture and slides, and automatically summarizing and outlining the transcript, and are each incorporated by reference herein.

The system of U.S. Pat. No. 6,789,228 does not customize the summarized material based on an individual student's needs, and implicitly assumes that all of the material is equally important (i.e. the importance of the topic is inherently reflected in the quantity of material presented for that topic).

U.S. Pat. No. 6,024,577 “NETWORK-BASED EDUCATION SYSTEM WITH CAPABILITY TO PROVIDE REVIEW MATERIAL ACCORDING TO INDIVIDUAL STUDENTS“UNDERSTANDING LEVEL”, issued 15 Feb. 2000 to Wadahama et al., and incorporated by reference herein, discloses a system for providing feedback to an instructor regarding each student's level of understanding of the presented material, and allowing the instructor to send additional material to each student, based on the student's level of understanding. At the end of each lecture, each student provides feedback in the form of a rating system, ranging from “Perfectly understood” to “Too difficult” to indicate his or her level of understanding, from which the instructor determines what additional material, if any, should be provided to the student.

The system of U.S. Pat. No. 6,024,577 relies upon the student's appreciation of what he or she understands or does not understand, relies upon an instructor who is willing to provide supplemental material to assist the students, and relies upon a correspondence between the provided supplemental material and the student's needs. Often, students fail to recognize the important aspects of a lecture, and thus their self-evaluation of their understanding level is questionable. Also often, an instructor may assume a basic background understanding on the part of the students, and provide supplemental material that also assumes this basic understanding. Another instructor, on the other hand, may assume that any lack of understanding is due to a lack of basic understanding, and may provide supplemental material that only covers what a student already understands.

It is an object of this invention to provide a lecture review system that reflects the relative importance of each topic. It is a further object of this invention to provide a lecture review system that reflects the student's particular needs.

These objects, and others, are achieved by a system and method that augments a recorded lecture based on the importance of the material and/or based on a student's needs. The importance of the material is based at least in part on questions from prior exams, and the student's needs are based at least in part on the student's performance on prior exams. The method of presenting the augmented material to the student may also be customized based on the student's learning style.

The invention is explained in further detail, and by way of example, with reference to the accompanying drawings wherein:

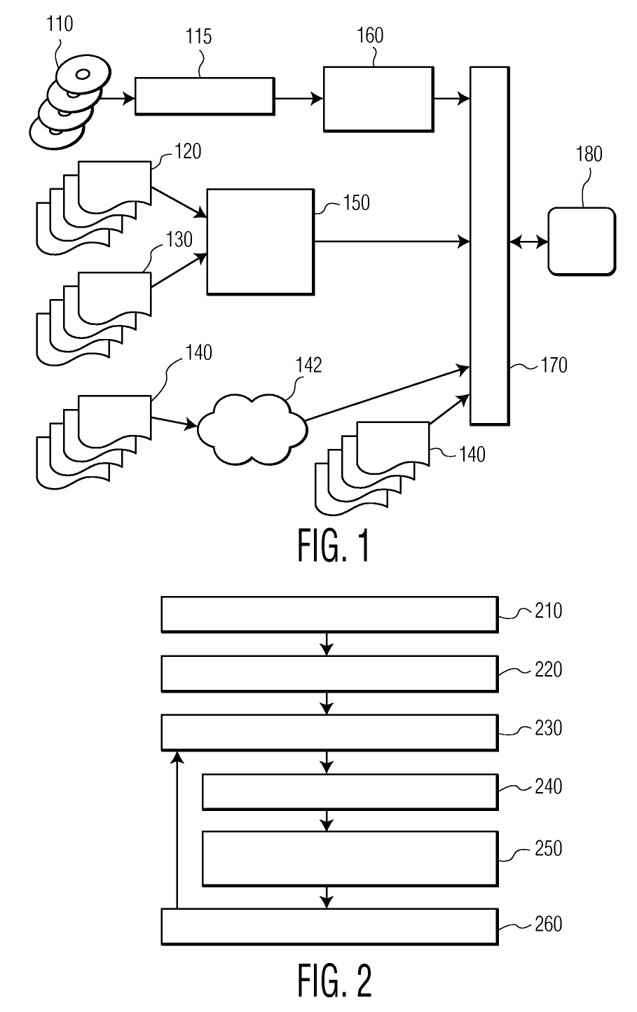

FIG. 1 illustrates an example block diagram of a lecture summarizing system in accordance with this invention.

FIG. 2 illustrates an example flow diagram for mapping examination questions to lecture material in accordance with this invention.

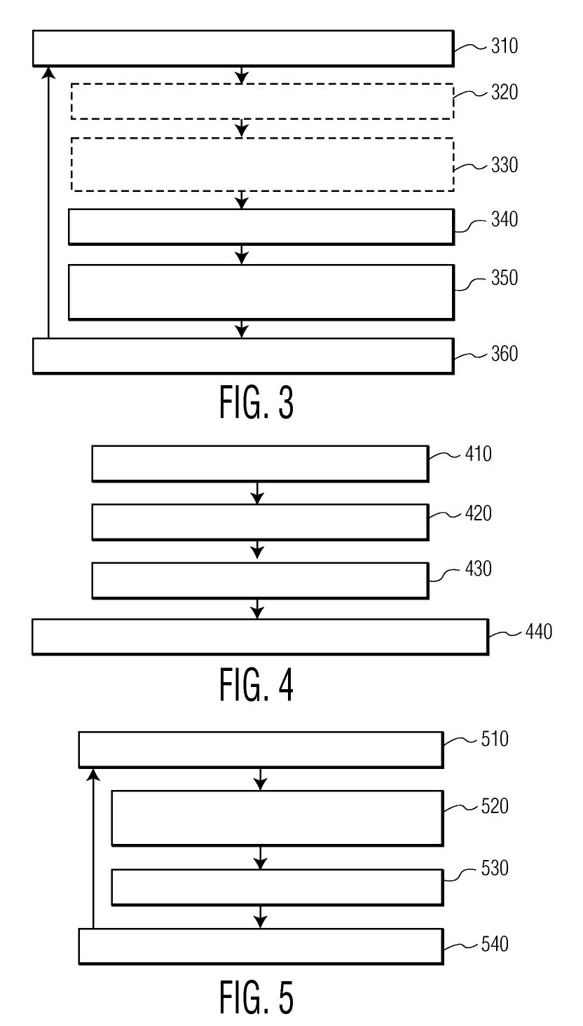

FIG. 3 illustrates an example flow diagram for identifying key segments of lecture material for a student in accordance with this invention.

FIG. 4 illustrates an example flow diagram for selecting segments of lecture material for creating a presentation in accordance with this invention.

FIG. 5 illustrates an example flow diagram for characterizing segments of lecture material in accordance with this invention.

The drawings are included for illustrative purposes and are not intended to limit the scope of the invention.

FIG. 1 illustrates an example block diagram of a lecture summarizing system in accordance with this invention, and FIGS. 2 and 3 illustrate example flow-diagrams for use in this system. Reference numerals beginning with “1” refer to elements in FIG. 1, “2” refer to elements in FIG. 2, and “3” refer to elements in FIG. 3.

The input to the example system includes lecture material 110, examinations 120, student responses 130, and other material 140, such as books, notes, web-pages, and the like. The other material 140, as well as any of the material 110, 120, 130, may be provided via a network 142. Different embodiments of the system in accordance with this invention may use fewer or more sets of input material 110-140.

Of particular note, the lecture summarizing system includes a topic area identifier 150 that is configured to identify key topics, based on the content of the examinations 120. Typically, the examinations 120 are prior examinations corresponding to the material contained in lecture material 110, but may also include less formal examinations of a student's understanding of the material 110, such as homework assignments and the like.

Optionally, the topic area identifier 150 is also configured to identify weak topics, based on the content of the student responses 130. These student responses 130 are preferably responses to prior examinations 120, or other examinations or assignments. A hierarchical organization of the examinations 120 may be used, wherein the responses 130 are responses to ‘routine’ examinations, and wherein the topic area identifier 150 can be configured to identify key topics based on prior ‘major’ examinations, such as mid-term and final exams.

To enable an association between key topic areas and the lecture material 110, the contents of the lecture material 110 are segmented into discrete topic areas by a topic segmenter 160. The lecture material 110 is transcribed (210 of FIG. 2) by a transcriptor 115 to facilitate this topic segmentation (220). Although the material 110 is illustrated in FIG. 1 using a CD icon, one or ordinary skill in the art will recognize that the material can be in any of a variety of forms, including both electronic and non-electronic forms. The transcriptor 115 includes the converters or transformers required to process the material 110 in its available form. The transcriptor 115 may include manual transcriptions, as well as automated techniques, or a combination of both. As used herein, the term transcription is used in its general sense, and includes, for example, speech to text conversion, as well as image to text conversion for transcribing information contained on slides, or written on whiteboards. Depending upon the particular subject matter, other transcription processes, such as symbol to text conversion, may also be used.

The transcriptor 115 also indicates where “breaks” occur in the material, to facilitate the segmentation of the material into “paragraphs”, and the segmentation of groups of paragraphs into topic areas. For example, the audio content of the lecture material may be identified as containing: silence, speech, noise, music, multiple speech, speech with background noise, speech with background music, and so on. In a majority of lectures, the content will most often be speech, silence, multiple speech and speech background noise. The pace and volume of speech may also be used to facilitate identifying a change of topic. As taught in U.S. Pat. No. 6,789,228, referenced above, other cues may be used to partition lecture material, including visual discontinuities that occur when presentation slides change, or electrical signals generated to effect such changes. In like manner, if the lecture material 110 is professionally prepared, visual breaks, title scenes, sub-titles, and the like can be used to distinguish different paragraphs and topics. If the lecture material 110 is multi-media, the transcriptor 115 may also be configured to reformat or restructure the material 110 to provide synchronization among the different forms of the material 110.

The topic segmenter 160 identifies the different topics within the material 110, and creates an index to each topic in the material 110. The segmenter 160 may also be configured to provide a summary and/or outline of segments in the material 110, using conventional summarization tools such as presented in U.S. Pat. No. 6,789,228. Using this index, a student is able to locate segments of the material 110 corresponding to each identified topic, is able to see what topics are covered in each lecture period, and so on.

In a preferred embodiment of this invention, the segmenter 160 also uses ancillary information, such as a course syllabus and lecture notes, to facilitate the identification and indexing of topics within the material 110. The preferred segmenter 160 also allows a user, either the instructor or the student, or both, to control or affect the identification and indexing process. For example, the user may rename the identified topics, group multiple identified topics into a more general topic, partition identified topics into more specific topics, and so on. Consistent with the teachings of U.S. Pat. No. 6,024,577, referenced above, the segmenter 160 may also allow the user to identify supplement material, such as material 140, that is also related to the identified topics.

The key area identifier 150 is configured to provide a mapping (230-260) between questions (230) on examinations 120 related to the material 110 and segments (240-250) within the material 110 identified by the topic segmenter 160. Preferably, this mapping is bidirectional, so that a user can review questions on prior exams related to each topic within the material 110, or can find where the material addressed by the question is presented in the lecture material 110. Because a single question may involve multiple topics, or a single topic may be addressed in multiple questions, the key area identifier 150 is configured to provide a many-to-many mapping function.

In a preferred embodiment, the key area identifier 150 and the topic segmenter 160 are closely coupled, so that the identification of topics is based on both the transcription of the lecture material 110 and the text of the questions on the exams 120. Also in a preferred embodiment, the key area identifier allows a user to control or affect the identification of the key area topic, as well as the determined mapping. For example, in a typical embodiment in a school environment, an ongoing student enterprise may collect prior exams and use the key area identifier 150 to provide an extensive mapping of each question to lecture material 110 that is provided by individual instructors, for use by future students.

In addition to providing a mapping between questions on exams 120 and segments of lecture material 110, the key area identifier 150 is also preferably configured to prioritize the identified key areas, based on the presence or absence of each area in the examination questions, the scoring weight of each question, and so on. Additionally, the prioritization/significance of the key areas may be based on how often each area is referenced throughout the lecture material 110, or how often each area is referenced during “key” lectures, such as the introductory lecture to the course, or the review lecture at the end of the course. This prioritization can be used for customizing the presentation of material for review before future exams, as discussed further below.

Optionally, the key area identifier 150 may also be coupled to prior responses 130 of a user, to specifically identify weak areas of the user (310-360 of FIG. 3). These responses 130 may be responses to prior exams, homework assignments, and so on. Preferably, the responses 130 have an associated ‘grade’ or ‘score’ that indicates the level of proficiency in the response (340). Preferably, the questions to which these responses correspond are included in the questions for which the key area identifier 150 has provided a mapping (320-330) to the lecture material 110, so that a user who receives a poor grade on a response can locate the segment of the lecture material 110 for review. Additionally, the grade on the responses 130 can be used to affect a ‘weight’ of the key areas corresponding to the questions (350), both favorably and unfavorably, so that the aforementioned prioritization of key areas for review are customized for each user.

The personalization module 170 provides a presentation of the identified key areas and the index to the lecture material 110, via a user interface 180. The module 170 is preferably configured to be customizable for a particular user, or a particular group of users, based on different users' preferences and/or different users' learning styles. For example, a particular user may prefer to see an overview of the lecture material 110, with hyperlinks to exam questions related to the material. Another user may prefer to see the exam questions, with hyperlinks to the segments of the lecture material. Another user may prefer to be presented with a syllabus with hyperlinks to either the lecture material or the exam questions.

As noted above, the module 170 may be operated in a variety of modes. It may be used in a simple overview mode, wherein the material is presented in a syllabus-like form, and allows the user to browse as desired through the material. It may also be used in a query mode, wherein the user can ask for material specific to a particular topic of interest, specific key words, and so on.

The module 170 may also be used in an exam-review mode, wherein the material is presented to the user in a determined order of importance, based on the identified key areas and/or weak areas. Preferably, the module 170 includes “intelligent” processes that customize the presentation based on the identified key and weak areas as well as based on the particular user's learning style and specific performance. For example, a generally poor performance may be indicative of a lack of basic understanding, and the module 170 provides additional emphasis on the materials presented at the beginning of the course. In like manner, atypical poor performance would be indicative of the need for review of specific material.

In like manner, the effectiveness of the review can be affected by the manner of presentation to the user, based on the particular user's learning style. The terms “right-brain” and “left-brain”, for example, are typically used to identify different types of personalities, and each of these personalities responds differently to different presentation styles. A “left-brain” person, for example, processes information sequentially, whereas a “right-brain” person processes information holistically. Left-brain scholastic subjects focus on logical thinking, analysis, and accuracy. Right-brain subjects, on the other hand, focus on aesthetics, hearing, and creativity. Lecture segments that consist of examples and explanations are generally characterized as “right-brain” presentations, whereas segments that cover the material step by step are generally classified as “left-brain” presentations.

The module 170 of FIG. 1 is generally configured to structure the presentation of the material based on whether the user is identified as a “left-brain” or “right-brain”. For example, the presentation to the “right-brain” person will include an initial overview of the material in the basic section, followed by progressive levels of details, whereas the presentation to the “left-brain” person preferably will include the overview followed by a sequential presentation of the material, with an emphasis on specific examples. The identification of each user's learning-style can be determined by providing a personality test to each new user of the system.

FIG. 4 illustrates an example flow diagram for creating a new presentation, as may be used in the module 170 of FIG. 1. At 410, the basic material for the class is organized into a basic section that is presented to all intended users. At 420, the characteristics of the intended user are obtained. For a non-user-specific presentation, the characteristics generally include whether the intended user is left-brain or right-brain, whether the presentation is intended as an overview or a remedial session, and so on. If the presentation is being prepared for a specific user, the characteristics generally also include the aforementioned identification of the user's proficiencies and weaknesses and other user-specific characteristics.

At 430, the value of each available section of material is determined, based on the characteristics of the intended user, such as whether the material is left-brain or right-brain, the relative importance of the material, and so on. The value of each section is intended to represent the learning outcome that is expected to be produced by presenting the section to the intended user, weighed by the aforementioned importance or priority of the material in the section. An assessment is also made as to the time that may be required to consume/learn each multimedia item. For example, an audio excerpt may take 3 minutes, while a graph may take 30 seconds; however, the auditory excerpt may be of higher value to the individual's style (e.g. on a scale 1 to 10 to have a value 7 while the graph might have a value 4).

At 440, the sections to be used in the presentation are selected, based on the value of the material to the user, as well as the estimated learning time, using any of a variety of optimization algorithms, common in the art. For example, the knapsack algorithm, which is structured to select items to place in a knapsack based on the items value and size. In this application, the value of each segment is determined as discussed above, and the size is the estimated time that takes for each of the segments to be consumed/learned.

To facilitate this learning-style dependent presentation of material, the topic segmenter 160 is preferably configured to classify particular sentences or paragraphs in the lecture material 110 by learning-style. For example, if the instructor begins a paragraph with “For example . . . ”, that paragraph may be characterized as a “left-brain” paragraph, while if the paragraph begins with “Overall . . . ”, that paragraph may be characterized as a “right-brain” paragraph. Note that this characterization of paragraphs is primarily intended to facilitate the formation of a presentation, and does not preclude a paragraph characterized as belonging to one learning-style from being included in a presentation in another learning-style.

FIG. 5 illustrates an example flow-diagram for characterizing paragraphs, as may be used in the segmenter 160 of FIG. 1. The loop 510-540 is illustrated as processing each paragraph, however one of ordinary skill in the art will recognize that different groupings of the material may be used, such as topic segments, sub-segments and so on.

At 520 a feature vector is extracted for each paragraph, wherein each element in the feature vector represents a count in a particular word category. Preferably, each word category includes a number of typical words that identify the category, and at 520, for each category, the number of words from that category in the corresponding paragraph is counted. Other techniques for capturing/summarizing the content of a paragraph may also be used.

At 530, the paragraph is characterized as being right-brain, left-brain, or both/neither. Statistically speaking, each learning style will have categories of words that are more populated than others. In a preferred embodiment, a support-vector-machine (SVM) is preferably used to facilitate the characterization of sentences or paragraphs by learning-style, wherein the SVM infers the important terms for characterizing sentences or paragraphs, based on previously characterized sentences or paragraphs. The SVM classifier is trained to recognize left-brain from right-brain using an initial training database of left/right-brain samples. Thereafter, for each new incoming lecture, each paragraph can be classified into left-brain, right-brain, or both/neither type of paragraphs.

The foregoing merely illustrates the principles of the invention. It will thus be appreciated that those skilled in the art will be able to devise various arrangements which, although not explicitly described or shown herein, embody the principles of the invention and are thus within its spirit and scope. For example, although the illustration of FIG. 1 implies an integration of the components 115, 150, 160, 170 as a single system, one of ordinary skill in the art will recognize that these components can each be provided independently. For example, the key area identifier 150 may be provided by a for-fee service provider who provides this key and/or weak area identification based on lectures 110 and exams 120 provided by a purchaser of the provider's services. In like manner, a key area identifier 150 can be used to identify key areas from exams, and the segmenter 160 can be used in a primarily manual mode to identify the location of these specific key areas in content material 110, without little or no use of a transcriptor 115. These and other system configuration and optimization features will be evident to one of ordinary skill in the art in view of this disclosure, and are included within the scope of the following claims.

In interpreting these claims, it should be understood that:

a) the word “comprising” does not exclude the presence of other elements or acts than those listed in a given claim;

b) the word “a” or “an” preceding an element does not exclude the presence of a plurality of such elements;

c) any reference signs in the claims do not limit their scope;

d) several “means” may be represented by the same item or hardware or software implemented structure or function;

e) each of the disclosed elements may be comprised of hardware portions (e.g., including discrete and integrated electronic circuitry), software portions (e.g., computer programming), and any combination thereof;

f) hardware portions may be comprised of one or both of analog and digital portions;

g) any of the disclosed devices or portions thereof may be combined together or separated into further portions unless specifically stated otherwise;

h) no specific sequence of acts is intended to be required unless specifically indicated; and

i) the term “plurality of” an element includes two or more of the claimed element, and does not imply any particular range of number of elements; that is, a plurality of elements can be as few as two elements.

1. A method comprising:
discerning (240) a topic of importance based on a prior examination question (120), and
identifying (250) a segment of lecture material (110) corresponding to the topic of importance.

2. The method of claim 1, further including:
segmenting (220) the lecture material (110) into a plurality of topic segments, from which the segment corresponding to the topic of importance is identified.

3. The method of claim 2, further including
transcribing (210) the lecture material (110) to facilitate the segmenting (220) of the lecture material (110).

4. The method of claim 2, further including
analyzing (230-260) prior examinations to identify a plurality of topics of importance, from which the topic of importance for identifying (250) the segment of lecture material (110) is discerned.

5. The method of claim 4, further including:
analyzing (310-360) prior responses (130) of a user to identify one or more weak topics of the user, and,
wherein the topic of importance is further discerned based on the one or more weak topics of the user.

6. The method of claim 1, further including
analyzing (230-260) prior examinations to identify a plurality of topics of importance, from which the topic of importance for identifying (250) the segment of lecture material (110) is discerned.

7. The method of claim 6, further including:
analyzing (310-360) prior responses (130) of a user to identify one or more weak topics of the user, and,
wherein the topic of importance is further discerned based on the one or more weak topics of the user.

8. The method of claim 1, further including
augmenting the segment of the lecture material (110) with material from other sources (140).

9. The method of claim 1, further including
providing (170) a presentation of the segment of the lecture material (110) based on a selected learning style (510-540).

10. The method of claim 9, wherein
the selected learning style is selected from at least:
a right-brain learning style, and
a left-brain learning style.

11. A method of providing a presentation of selected segments of lecture material (110), comprising:
identifying (420) whether the presentation is intended for a right-brain or left-brain user, and
selecting (430-440) some or all of the selected segments based on whether each segment is characterized as right-brain oriented or left-brain oriented.

12. The method of claim 11, further including:
characterizing (510-540) each segment of the lecture material (110) as being at least one of right-brain oriented or left-brain oriented.

13. The method of claim 12, wherein
characterizing (510-540) each segment includes:
determining (520) a feature vector based on words in the segment, and
characterizing (530) the segment based on the feature vector.

14. The method of claim 13, wherein
characterizing (510-540) each segment also includes
training a learning engine to characterize training segments based on training feature vectors.

15. The method of claim 11, further including
selecting (410) introductory segments independent of whether the introductory segments are left-brain oriented or right-brain oriented.

16. The method of claim 11, wherein
selecting (430-440) some or all of the selected segments is also based on a performance (340-350) of the user on one or more examinations related to the lecture material (110).

17. The method of claim 11, wherein
selecting (430-440) some or all of the selected segments is also based on an estimated time duration for the user to comprehend each segment.

18. The method of claim 11, wherein
selecting (430-440) some or all of the selected segments is also based on one or more of the following:
an information content of each segment,
a significance factor associated with each segment, and
reference to the information content of each segment in other segments.

19. A presentation system comprising:
a topic segmenter (160) that is configured to segment lecture material (110) into a plurality of segments based on a plurality of topics,
a key area identifier (150) that is configured to provide a mapping between questions on examinations (120) related to the lecture material (110) and the plurality of segments of the lecture material (110), based on a topic of each question, and
a presentation module (170) that is configured to facilitate access to select segments of the lecture material (110) corresponding to one or more of the questions on the examinations (120).

20. The presentation system of claim 19, wherein
the presentation module (170) is further configured to facilitate access to select questions on the examinations (120) corresponding to one or more segments of the lecture material (110).

21. The presentation system of claim 19, wherein
the presentation module (170) is configured to provide a presentation of selected segments of the lecture material (110), based on a selection criteria that is based at least in part on the questions on the examinations (120) related to the lecture material (110).

22. The presentation system of claim 21, wherein
the selection criteria is further based on:
a right-brain or left-brain orientation of each segment of the lecture material (110),
an information content of each segment,
references to the information content of each segment in other segments,
a significance factor associated with each segment, and
an estimated learning-time duration associated with each segment.
